(19) United States
(12) Patent Application Publication
(10) Pub. No.: US 2014/0200813 A1
(43) Pub. Date: Jul. 17, 2014

(54) SYSTEMS AND METHODS FOR SEISMIC DATA PROCESSING USING KINEMATIC ANALYSIS OF SOURCE-RECEIVE MIGRATION ADCIGS

(71) Applicant: CGG SERVICES SA, Massy Cedex (FR)

(72) Inventors: Jean-Philippe MONTEL, Massy (FR); Gilles LAMBARE, Saint Fargeau Ponthierry (FR)

(73) Assignee: CGG SERVICES SA, Massy Cedex (FR)

(21) Appl. No.: 14/152,208

(22) Filed: Jan. 10, 2014

Related U.S. Application Data
(60) Provisional application No. 61/751,563, filed on Jan. 11, 2013.

(51) Int. Cl. G01V 1/30

(52) U.S. Cl. CPC G01V 1/303
USPC 702/14

(57) ABSTRACT

Systems and methods are provided for determining a starting position and direction of a ray for use in generating a velocity model based at least in part on a kinematic analysis of Angle Domain Common Image Gathers (ADCIGs) obtained by a Wave Equation Migration (WEM) process. A method includes: determining a migrated spatial dip from a stack; determining a slope of a residual move-out (RMO); remapping a migrated value into a first value; repositioning the starting position of the ray based at least in part on the migrated spatial dip from the stack, the slope of the RMO and the first value; and computing the starting direction of the ray.

### RELATED APPLICATION

The present application claims priority under 35 U.S.C. §119(e) to U.S. Provisional Patent Application Ser. No. 61/751,563, filed Jan. 11, 2013, for “Slant Stack ADCIG Ray Based Demigration”, the entire contents of which are expressly incorporated herein by reference.

### TECHNICAL FIELD

The embodiments relate generally to methods and systems for seismic data processing and, more particularly, to mechanisms and techniques for more efficiently providing an accurate image of a subsurface structure based on the seismic data using kinematic analysis.

### BACKGROUND

A widely used technique for searching for hydrocarbons, e.g., oil and/or gas, is the seismic exploration of subsurface geophysical structures. Reflection seismology is a method of geophysical exploration to determine the properties of a portion of a subsurface layer in the earth, which information is especially helpful in the oil and gas industry. Marine-based seismic data acquisition and processing techniques are used to generate a profile (image) of a geophysical structure (subsurface) of the strata underlying the seafloor. This profile does not necessarily provide an accurate location for oil and gas reservoirs, but it may suggest, to those trained in the field, the presence or absence of oil and/or gas reservoirs. Thus, providing an improved image of the subsurface in a shorter period of time is an ongoing process.

The seismic exploration process includes generating seismic waves (i.e., sound waves) directed toward the subsurface area, gathering data on reflections of the generated seismic waves at interfaces between layers of the subsurface, and analyzing the data to generate a profile (image) of the geophysical structure, i.e., the layers of the investigated subsurface. This type of seismic exploration can be used both on the subsurface of land areas and for exploring the subsurface of the ocean floor.

Marine reflection seismology is based on the use of a controlled source that sends energy waves into the earth, by first generating the energy waves in or on the ocean. By measuring the time it takes for the reflections to come back to one or more receivers (usually very many, perhaps in the order of several dozen, or even hundreds of receivers), it is possible to estimate the depth and/or composition of the features causing such reflections. These features may be associated with subterranean hydrocarbon deposits.

Seismic waves are initiated by a source, follow one or more paths based on reflection and refraction until a portion of the seismic waves are detected by one or more receivers. Upon detection, data associated with the seismic waves is recorded and then processed for producing an accurate image of the subsurface. The processing can include various phases, e.g., velocity model determination, prestack, migration, poststack, etc., which are known in the art and thus, their description is omitted here.

Progress in prestack depth imaging has been considerable in the past. The theoretical progress has provided better methods for extrapolating wavefields measured at the earth's surface into the subsurface, and the practical progress has linked the migrations more closely with velocity model building and interpretation. Migration is process of propagating, for example, a wavefield measured at a receiver location to a reflector located in the subsurface. The migration may also be applied to wavefields generated by a source.

In complex subsurface areas, imaging difficulties are due to two components: prestack depth velocity model building and migration algorithms. Velocity model building estimates a velocity model (e.g., how the sound wave propagates through the various layers of the earth) for the simulation of seismic wave propagation that takes place during migration. This model forms the long wavelength (macro) part of the earth model, and the migration provides the short wavelength (reflectivity) part. Seismic ray-based tomography is a widely used tool for model building, but the nonlinearity and uncertainty of the ray-based tomography algorithms exposes tomography as a weak link in the imaging process. Another weak link in the imaging process is the poor seismic illumination of regions beneath the complex overburden (e.g., salts, overthrust structures, etc.), which makes adequate imaging difficult or even impossible.

Until recently, Kirchhoff migration has been the workhorse method for prestack depth migration. This method has proven successful over numerous examples when the velocity variations are minor. This method has also formed the basis for the “true-amplitude” migration. This algorithm migrates the input seismic data one trance at a time or one local group of traces at a time; these processes imply that the cost of Kirchhoff migration is proportional to the number of input traces. However, when the number of input traces is relatively small within the migration aperture (as is usually the case with marine narrow azimuth surveys), Kirchhoff migration yields an efficient algorithm. On the contrary, when the number of input traces is large within the migration aperture (as is usually the case with marine wide azimuth surveys), efficiency might be lost as the computational task becomes more demanding.

Also, using raytracing to approximate the Green's function of wave propagation may compromise the accuracy of Kirchhoff migration, especially when the wavefield is complicated. A traditional approximation, e.g., choosing a single ray arrival of the complicated wavefield at each image location, determines a noisy image in areas where there are many ray arrivals. Multi-arrival Kirchhoff migration algorithms overcome this problem, but they tend to be complicated and relatively inefficient in three dimension (3D).

According to other approaches, beam prestack depth migration methods approximate the Green's function with an expression that allows multiple arrivals to be imaged without excessive algorithmic complication, and it can be applied in a true-amplitude sense. As for Kirchhoff migration, however, the Green's function approximation used by beam migration relies on ray tracing and can become inaccurate if the migration velocity model contains extremely strong variations (e.g., salt bodies) and requires excessive smoothing. Still, the beam migration's ability to image complex structures and to control certain types of migration noise can usually ensure significantly better images in complex areas than single arrival Kirchhoff migration algorithms.

While Kirchhoff and beam migration methods use rays to approximate the Green's functions for wave propagation, so-called wave-equation migration algorithms use full waveform Green's functions that are numerically generated, for example, by finite differences. The most computationally efficient algorithms for doing this are collectively called one-way wave equation migration (OWEM). These algorithms decompose seismic wavefields inside the earth into up-going waves and down-going waves under the assumption of no interaction between these two wavefields; that is, no turning wave and vertical reflection generation during the synthesis of wave propagation. Over a very large and growing body of examples, OWEM has solved the problems of multi-arrivals better than single arrival Kirchhoff migration. For wide azimuth seismic surveys, where the number of input traces is large compared with the migration aperture, OWEM tends to gain efficiency relative to Kirchhoff migration. For such surveys, efficient implementation of OWEM algorithms can be built either for common shot migration or for plane wave migration.

However, there are some major limitations of OWEM algorithms. First, turning waves are missing in the wave propagation synthesis, which results in the high dip events around 90° being poorly imaged; second, the wave propagation synthesis only ensures the accuracy of the phase of the wavefield, while amplitudes of the wavefield are much less reliable and need further correction.

Use of the two-way wave equation in depth migration began some time ago in an algorithm called reverse-time migration (RTM). However, this approach was limited due to its need for computer power. With increases in computer power, RTM has developed rapidly over the last few years, and theoretical advantages such as dip-unlimited accurate wave propagation and improved amplitudes have provided imaging benefits in practice. For example, in complex subsalt and salt flank areas, the numerical Green's functions from finite difference to the two-way wave equation have better amplitude behavior, so it is easier to incorporate amplitude corrections into RTM than into OWEM. In addition to its ability to handle complex velocities distributions, many current RTM algorithms can handle anisotropic media such as vertical transverse isotropy (VTI) and tilted transverse isotropy (TTI). On real data imaging examples, TTI RTM has given the best images in a complex Gulf of Mexico wide azimuth survey, though the velocity models for TTI migration were simplified as structurally conformable transversely isotropy (STI), which requires the anisotropic symmetric axis consistent with the reflectors' normal vectors.

With the improved accuracy of RTM comes increased sensitivity to the accuracy of the velocity model. This sensitivity causes notable improvement in RTM images when the velocity model is accurate, but is also causes notable degradation of RTM images when the velocity model is not accurate. For this reason, migration velocity analysis is more important for RTM than it is for other depth migration methods.

The link between migration and velocity model building is a set of common image gathers (CIGs) produced by the migration algorithms. A CIG is a set of images, all at the same image location (usually at the location of the reflector in the subsurface), with each image formed from different subsets of input data. For example, a single common offset/common azimuth data volume, which is a subset of the full acquired prestack seismic data set, can be used to 3D image the earth. The collection of images from all the sub-datasets with different offset and azimuth forms the CIGs. The CIGs include plural traces. The CIGs can have all traces with different offsets (with all the azimuthal information summed together), or the CIGs can have all traces with different offsets and azimuths.

The CIGs are commonly used for depth domain amplitude variation with offset (AVO) analysis, and migration-based analysis. With a correct velocity model, all the images at the same image location should focus at the same depth, causing reflection events of the CIGs to appear flat. The flatness of seismic events on CIGs is one of the criteria for validating the velocity model by focusing analysis. When events on the CIGs are not flat, geophysicists can improve their migration velocity models by analyzing the curvature of the events, using the analysis to guide a velocity update.

For Kirchhoff migration, there is no significant additional cost to compute common offset CIGs (COCIGs). On the other hand, migrating common-offset volumes by OWEM or RTM is expensive, so COCIGs are not generally available for those migration methods.

The quality limitations of COCIGs are caused, in part, by the underlying limitations of ray-based migration. More fundamentally, COCIGs suffer from migration artifacts due to multiple paths of wave propagation, whether or not the migration methods are capable of handling multiple paths of wavefleld accurately, potentially causing difficulties for velocity analysis and amplitude versus reflection angle (AVA) analysis. In fact, CIGs whose traces are indexed by any attribute on the recording surface, such as source/receiver offset or surface incidence angle of the source energy, are susceptible to such artifacts. In this regard, it was shown that a necessary condition for artifact free CIGs is to be parameterized in a subsurface angle domain, such as in a reflection angle or opening angle. This was illustrated in 2D using multi-arrival Kirchhoff migration on the Marmousi synthetic dataset and subsequent work has extended this showing to anisotropic media, or 3D using CIGs in reflection angle/azimuth angle, and to 3D analysis in multiple angle domains (reflection angle, dip angle, azimuth angle, etc.).

Compared with multi-arrival Kirchhoff and beam migrations, OWEM and RTM appear to have limited capabilities for CIGs indexed in the surface offset domain. In the subsurface angle domain, an approach was proposed that outputs local subsurface offset CIGs from OWEM and then converts them to subsurface (reflection) angle domain CIGs (ADCIGs). Converting local subsurface offset CIGs into ADCIGs has been relatively simple for the 2D isotropic case. This approach requires the migration imaging condition to be applied at a range of subsurface offsets, forming subsurface offset CIGs; next a 2D Fourier transform is applied to the local offset CIG; then the transform wavenumber is mapped to the reflection angle.

ADCIGs were initially developed for Kirchhoff based migration and, more recently, adapted for RTM as a built-in imaging condition and for WEM as a post migration process. To further improve velocity models, kinematic analysis of ADCIGs obtained by Kirchhoff migration and RTM have been performed. Generally speaking, kinematic analysis focuses on motion characteristics but without reference to mass or force characteristics. However, there are other seismic data processing techniques which can use ADCIGs that may be also improved through the use of kinematic analysis if it could be determined how to apply such techniques thereto.

Accordingly, it would be desirable to provide methods and systems associated with the use of kinematic analysis.

### SUMMARY

According to an embodiment, there is a method for determining, by a computing device, a starting position and direction of a ray for use in generating a velocity model based at least in part on a kinematic analysis of Angle Domain Common Image Gathers (ADCIGs) obtained by a Wave Equation Migration (WEM) process, the method comprising: determining a migrated spatial dip from a stack; determining a slope of a residual move-out (RMO); remapping a migrated value into a first value; repositioning the starting position of the ray based at least in part on the migrated spatial dip from the stack, the slope of the RMO and the first value; and computing the starting direction of the ray at least in part by using kinematic analysis.

According to an embodiment there is a method for determining, by a computing device, a starting position and direction of a ray for use in generating a velocity model based at least in part on a kinematic analysis of Angle Domain Common Image Gathers (ADCIGs) obtained by a Wave Equation Migration (WEM) process, the method comprising: determining, by a processor, a migrated spatial dip from a stack; determining, by the processor, a slope of a residual move-out (RMO); remapping, by the processor, a migrated value into a first value; repositioning, by the processor, the starting position of the ray based at least in part on the migrated spatial dip from the stack, the slope of the RMO and the first value; computing, by the processor, the starting direction of the ray by solving a nonlinear system of equations linking the migrated spatial dip and an opening angle to a source and a receiver angle; generating, by the processor, the velocity model; and generating, by the processor, an image of a subsurface using the velocity model.

According to another embodiment, there is a method for generating a subsurface image of a geographical area based on processing of seismic data, the method comprising: performing, by a processor, a Wave Equation Migration (WEM) process which results in a set of Angle Domain Common Image Gathers (ADCIGs); performing, by the processor, a kinematic analysis on the set of ADCIGs; and generating, by the processor, the subsurface image based at least in part on the kinematic analysis on the set of ADCIGs.

### BRIEF DESCRIPTION OF THE DRAWINGS

The accompanying drawings illustrate exemplary embodiments, wherein:

FIG. 1 illustrates a land seismic survey according to an embodiment;

FIG. 2 shows a flowchart of a method according to an embodiment;

FIG. 3 depicts ray parameters and angle relations according to an embodiment;

FIGS. 4 and 5 show curvatures associated with an event according to embodiment;

FIG. 6 depicts a marine seismic gather process with a data acquisition system according to an embodiment;

FIG. 7 shows streamers with a curved profile according to an embodiment;

FIG. 8 illustrates a multi-level source according to an embodiment;

FIG. 9 shows a flowchart of a method according to an embodiment;

FIG. 10 shows a flowchart of another method according to an embodiment; and

FIG. 11 illustrates a seismic data acquisition system with components according to an embodiment.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will convey the scope of the inventive concept to those skilled in the art. The scope of the embodiments is therefore defined by the appended claims. The following embodiments are discussed, for simplicity, with regard to the terminology of source wavefields, receiver wavefields, common image gathers (CIGs), and reverse time migration (RTM) for processing seismic data. However, the embodiments to be discussed next are not limited to these systems or methods, but may be applied to other methods for producing images of the subsurface.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

According to embodiments, and in order to address, among other things, the opportunities for improving subsurface images as discussed in the Background, a kinematic analysis of the angle domain common image gathers (ADCIGs) obtained by a source-receiver migration process can be performed. The theoretical analysis of the imaging equation governing the reverse time migration (RTM) algorithm building ADCIGs from subsurface offset gather can give a solution for ray based demigration of picked information in the migrated cube and therefore opens the possibility to use ray based tomographic engine tools to update the velocity from RTM. Prior to discussing embodiments in detail, an environment in which the embodiments described herein can be implemented or used with is presented.

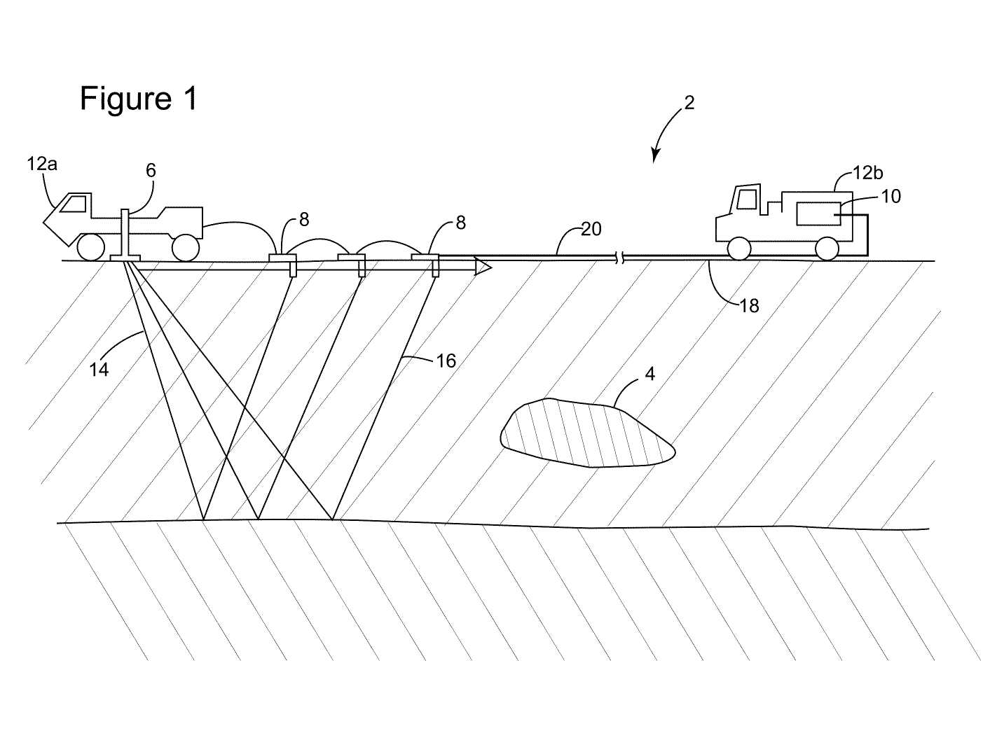

Embodiments described herein can be used in support of land or marine seismic exploration systems for transmitting and receiving seismic waves intended for seismic exploration. An example of such a land system is shown in FIG. 1. FIG. 1 depicts schematically a land seismic exploration system 2 for transmitting and receiving seismic waves intended for seismic exploration in a land environment. At least one purpose of system 2 is to determine the absence, or presence of hydrocarbon deposits 4, or at least the probability of the absence or presence of hydrocarbon deposits 4. System 2 includes a source 6 operable to generate a seismic signal (transmitted waves 14), a plurality of receivers 8 (e.g., geophones) for receiving seismic signals 16 and converting them into electrical signals, and seismic data acquisition system 10 (that can be located in, for example, vehicle/truck 12 (a and/or b)) for recording the electrical signals generated by receivers 8. Source 6, receivers 8, and data acquisition system 10 can be positioned on the surface of ground 18, all of which can be interconnected by one or more cables 20. FIG. 1 further depicts a single source 6, but it should be understood that source 6 can be composed of multiple or a plurality of sources 6, as is well known to persons skilled in the art.

Embodiments described herein are not limited to only being used in support of such a system as shown in FIG. 1 but instead can be used in support of other systems and methods which collect seismic data for which the systems and methods associated with seismic data processing, e.g., kinematic analysis, described herein can improve the quality of the processed data and displayed images. For example, more or fewer receivers and sources could be used. Additionally, kinematic analysis associated with source-receiver migration ADCIGs may be used, in some scenarios, for processing and imaging marine seismic data.

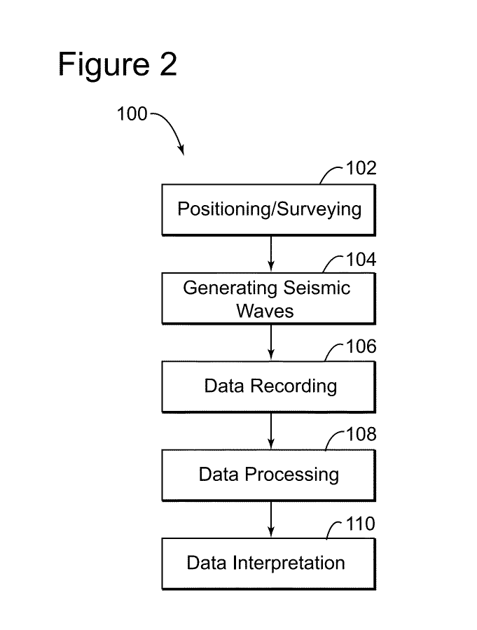

Embodiments described herein relate to seismic exploration, and in support of that by improving systems and methods for the processing of seismic data. The main purpose of seismic exploration is to render the most accurate possible graphic representation of specific portions of the Earth's subsurface geologic structure (also referred to as a Geological Area of Interest (GAI)). The images produced allow for exploration companies to accurately and cost-effectively evaluate a promising target (prospect) for its oil and gas yielding potential, e.g., hydrocarbon deposits. FIG. 2 illustrates a general method for seismic exploration. The seismic exploration method 100 can be broken down into five general process steps and, although a detailed discussion of any one of the process steps would far exceed the scope of this document, a general overview of the process can aid in understanding where the different aspects of the interpolation embodiments described herein can be used.

A method for seismic exploration 100 can include a plurality of steps. At step 102, positioning and surveying of the potential site for seismic exploration occurs to ensure that the GAI will be appropriately shot and recorded during the acquisition. At step 104, seismic signals are transmitted. At step 106, data recording of the reflected waves occurs. In a first part of step 106, receivers receive and most often digitize the data, and in a second part of this step, the data is transferred to some form of a recording station or device. At step 108, data processing occurs. Data processing generally involves enormous amounts of computer processing resources, including the storage of vast amounts of data, multiple processors or computers running in parallel and the like. Among other things, the data processing step 108 can include interpolation to provide reconstructed trace to improve PSTM as described above in the Background section. Finally, at step 110, data interpretation occurs and results can be displayed in multiple dimensions, e.g., data can be processed using techniques which use one, two, three or even five dimensions of data, while displays of data can often be found in two, three or four dimensional form. For example, a three dimensional (3D) plot or graph over time (the fourth dimension) can be created and displayed.

Having described various environments in which seismic sources and receivers can operate, embodiments describing processing data associated with such seismic sources and receivers are now described.

As mentioned earlier, in recent years, effort has been put into computing a certain type of migrated data gather known as the angle domain common image gather (ADCIG). This type of gather was initially developed for Kirchhoff ray based migration and was more recently also adapted for RTM as a built-in imaging condition or for wave equation migration (WEM) as a post migration process. According to an embodiment a kinematic analysis of the ADCIGS obtained by source-receiver migration can be performed to enhance the velocity model of the received seismic waves. A description of source-receiver migration ADCIGs will first be described, followed by embodiments associated with the kinematic analysis of such ADCIGs.

Seismic data without migration is oriented with respect to the observation points, i.e., the receivers. Migration involves repositioning data elements in the received seismic data set to instead make their locations be associated with the locations of the corresponding reflectors. There are many different types of migration which can be used for different seismic applications.

Source-receiver migration was initially proposed by Claerbout (Claerbout, “Imaging the Earth Interior,” Blackwell Scientific Publication Co., 1985). It has been recognized as the most appropriate for migration velocity analysis in case of imaging in complex media (Biondi, B. et al., “Angle domain common image gather for migration velocity analysis by wavefield-continuation imaging,” geophysics, 69, 2004). As shown by Biondi (Biondi, B., “Equivalence of source-receiver migration and shot profile migration,” geophysics, 68, no. 4, pp. 1340-1347, 2003) it can be expressed as a sum of common shot migrations. Then the stacked image in 2D I(x,z), at an image point (x,z), becomes the sum of the zero-lag cross-correlation of the forward propagated wavefield Sₛ(x,z,t) with its associated backward propagated receiver wavefield R̅ₛ(x,z,y) as shown below in Equation (1).

$$I ( x , z ) = \text{?} \text{?} \text{?} ( x , z , t ) \overline{{R}_{s}} ( x , z , t ) . \\ \text{?} \text{indicates text missing or illegible when filed} \qquad ( 1 )$$

However, by summing all of the receivers and shots when forming the image, the surface offset dataset loses information and, with that, destroys the possibility of obtaining common image gathers (CIGs). Equation (1) can be extended (Biondi, B. et al., “Prestack imaging of overturned reflections by reverse time migration: 72^{nd} Ann. Internat. Mtg. Soc. of Expl.,” Geophys., pp. 1284-1287, 2002) by considering cross-correlations of wavefields shifted horizontally at the image point. This extra dimension can be interpreted as a subsurface offset, h, providing subsurface offset common image gathers as shown below in Equation (2).

$$I ( x , z , h ) = \text{?} \text{?} \text{?} ( x - h , z , t ) \overline{{R}_{s}} ( x + h , z , t ) . \\ \text{?} \text{indicates text missing or illegible when filed} \qquad ( 2 )$$

A section of this image taken at constant x location becomes a horizontal subsurface offset common image gather and the conventional stacked image will be the extraction of the h=0 slice. Note that for any value of h the image I(x,z,h) is built through a stack of all migrated data, thus greatly reducing the artifacts associated with the partial migrations involved in common shot or common surface offset migrations (Stolk and Symes, 2004).

The subsurface offset gathers generated in this manner look quite different from conventional surface offset gathers and are more susceptible to errors in the velocity model. For example, when using the correct velocity model with subsurface offset gathers, all of the energy focuses at a zero subsurface offset while, when using an incorrect velocity model, the energy is spread in both the subsurface offset and vertical directions. Another way to address this issue is to transform these gathers into ADCIGs. Sava and Fomel (Sava, P., et al., “Angle-domain common gathers by wavefield continuation methods,” Geophysics, 63, pp. 1065-1074, 2003) presented an efficient method for transforming these CIGs into ADCIGs. Their method involves a slant stack transformation as shown below in Equation (3).

$$I ( x , \overline{z} , p ) = \int d h \int d z \partial ( z - \overline{z} - p h ) \text{?} \text{?} \text{?} ( x - h , z , t ) \overline{{R}_{s}} ( x + h , z , t ) , \\ \text{?} \text{indicates text missing or illegible when filed} \qquad ( 3 )$$

where p=−tan(θ) with θ being the aperture angle at image point and z̅ the depth in the ADCIG. Equation (3) can be performed as a post processing operation after the imaging process described by Equation (2), where the linear Radon transform maps the events in the subsurface offset gather into events in the angle gather, and where events are the arrival of seismic energy which can be, e.g., reflected or refracted energy. However, it is believed that the velocity models associated with such ADCIGs can be improved by applying a kinematic analysis to the source-receiver migration of ACDIGs as will now be described according to an embodiment.

The imaging process shown in Equation (3) involves common shot and common receiver wavefield extrapolations for which the stationary phase assumption can be applied as frequency ω→∞. According to this high frequency approximation, a kinematic analysis can be constructed based on the framework that an event T [symbol] (s,r) will focus at position (x,z,h) if (s,r) is such, as shown below in Equations (4)-(6), that

$$\begin{matrix}{T}_{obs} ( s , r ) - {T}_{sr} ( x , z , h ; s , r ) = 0 & ( 4 ) \\ \partial ( {T}_{obs} ( s , r ) - {T}_{sr} ( x , z , h ; s , r ) ) / \partial s = 0 & ( 5 ) \\ \partial ( {T}_{obs} ( s , r ) - {T}_{sr} ( x , z , h ; s , r ) ) / \partial r = 0 \\ With {T}_{sr} ( x , z , h ; s , r ) = {T}_{s} ( x + h , z ; s ) + {T}_{r} ( x - h , z ; r ) . & ( 6 )\end{matrix}$$

Now if Equation (4) is expanded to its first order equivalent:

$$\text{?} + \text{?} \text{?} \text{?} \text{?} \text{?} \text{?} - \text{?} \text{?} - \text{?} \text{?} - \text{?} \text{?} = 0 \\ \text{?} \text{indicates text missing or illegible when filed} \qquad ( 7 )$$

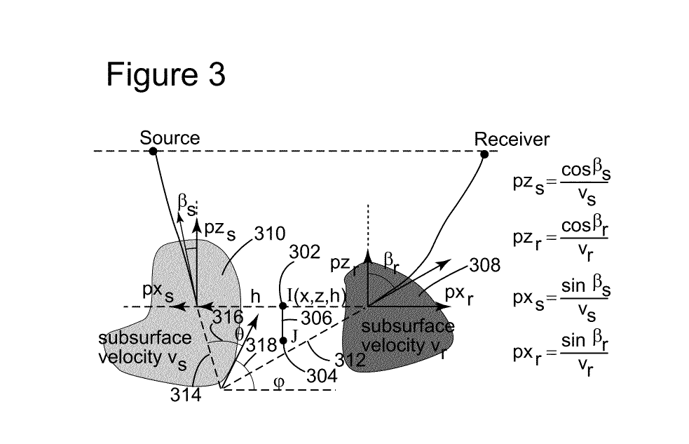

Then it can be simplified by using Equations (5) and (6). By setting δh=0 (looking at a common subsurface offset panel) and δx=0 (looking at a subsurface offset gather), the following simplification of Equation (7) is obtained:

$$\begin{matrix}\text{?} = - \text{?} \\ and \\ \text{?} = - \text{?} \\ With & ( 8 ) \\ \text{?} = \text{?} & ( 9 ) \\ \text{?} = \text{?} = \text{?} & ( 10 ) \\ \text{?} = \text{?} \\ \text{?} \text{indicates text missing or illegible when filed} & ( 11 )\end{matrix}$$

where Tₛ and Tᵣ are the one-way travel times between image points and surface positions of the source and receiver, respectively. Equations (8)-(11) relate to ray parameters to selected information in the associated migrated image. More specifically, Equation (8) describes the migration focalization equations, while Equations (9)-(11) describe the derivative terms contained in Equation (8) and are a function of ray parameter quantities with the following relation: Equation (9) is associated with pxₛ+pxᵣ of FIG. 3, Equation (10) is associated with −pxₛ+pxᵣ of FIG. 3, and Equation (11) is associated with pzₛ+pzᵣ of FIG. 3.

To better understand the kinematic analysis framework described above, FIG. 3 shows the relations between ray parameters and various angles as well as image point I 302 and ray starting point J 304 (which is also an image point). Image point I 302 is generated from migration processing, e.g., Equation (2). This position I 302 is the recomputed by a reverse slant stacking process, e.g., Equation (9), which results in the ray starting position J 304. In this example, J 304 is a distance h tan θ below I 302. Furthermore, for this example and in many cases, the velocities vₛ and vᵣ may not be the same. To determine the ray starting direction, the nonlinear systems of equations described herein are solved. Returning to FIG. 3, there is an aperture θ 316, a dip φ 318, a receiver wavefield 308 which is located at a distance +h (in the x axis) from image point I 302, and a source wavefield 310 which is located at a distance of −h (in the x axis) from image point I 302. Bₛ and Bᵣ represent a source ray and a receiver ray both with respect to the vertical axis, respectively. The x and z components of the rays can be calculated as shown by the vector equations shown in FIG. 3. The rays can then be projected back as shown by the dotted lines 312 and 314 from which θ and φ are determined.

According to an embodiment, using the relations between ray parameters and angles shown in FIG. 3, the dip (φ) and opening angle or aperture (θ) can be calculated as:

$$tan ϕ = - \text{?} \\ \text{?} = - \text{?} \\ \text{?} \text{indicates text missing or illegible when filed} \qquad ( 12 )$$

In other words, Equation (12) is a form of Equation (8) that is rewritten using angles instead of ray parameters to provide an easier geometrical understanding of FIG. 3. So it can be seen that when Vₛ=Vᵣ, there is a simple relation between the dip and opening angle and the angle to source and receiver. But when Vₛ≠Vᵣ, it will be necessary to solve a non-linear problem to recover the correct pair of angle to source and receiver from the dip, the opening angle and the velocities at the two subsurface positions corresponding to offset h.

According to an embodiment, Equation (12) defines the relations between ray parameters and the kinematic information picked in the subsurface domain, e.g., the dip tan φ=θz/θx and the slope of the RMO tan δ=−∂z/∂h. However, this information is not fully determinable. Instead only the dip and the RMO picked in the ADCIG computed by slant stack are accessible. The dip can be picked from the migrated stack h=0 but, instead of slope ∂z/∂h, the ADCIG provides ∂z/∂θ. However, this available information still enables determination of the stationary source and receiver locations for a picked reflection event. This can be done by, for example, analysing the kinematic behaviour of the Radon transform, which can be expressed in the z Fourier domain as shown in Equation (13):

$$\begin{matrix}P ( \overline{z} , p ) = \int d h \int d z \partial ( z - \overline{z} - p h ) f ( z , h ) \\ = \int d h \int d {k}_{z} \text{?} f ( {k}_{z} , h ) .\end{matrix} \\ \text{?} \text{indicates text missing or illegible when filed} \qquad ( 13 )$$

To analyze the kinematic behavior of Equation (13), consider an event in a subsurface offset gather. The event is characterized by the surface x_{mig}(x,h) in the depth migrated cube. According to specularity conditions of the Radon transform, the event z_{mig}(x,h) will focus in the ADCIG at position z̅_{mig}(x,p_{spec}) such that:

$${p}_{spec} = \partial {z}_{mig} / \partial h and {\overline{z}}_{mig} ( x , {p}_{spec} ) = {z}_{mig} ( x , h ) - {p}_{spec} h \qquad ( 14 )$$

Symmetrically, according to specularity conditions of the inverse Radon transform, the event z̅(x,p) in the ADCIG domain will focus in the subsurface offset at the position z(x,h_{spec}).

$${h}_{spec} = \partial {\overline{z}}_{mig} / \partial h and {z}_{mig} ( x , {h}_{spec} ) = {\overline{z}}_{mig} ( x , p ) + p {h}_{spec} \qquad ( 15 )$$

According to an embodiment, combining the relations shown in Equations (14) and (15), and considering Equation (7) at the specularity point of the inverse Radon h_{spec}=−∂ z̅/∂p, the following is obtained:

$${\overline{z}}_{mig} ( x , {p}_{spec} ) = {z}_{mig} ( x , {h}_{spec} ) - {p}_{spec} {h}_{spec} \qquad ( 16 )$$

Equation (16) can be expanded to a first order equation as shown below:

$$\text{?} \text{?} = \text{?} \text{?} - \text{?} - \text{?} \\ \text{?} \text{indicates text missing or illegible when filed} \qquad ( 17 )$$

By replacing ∂ z̅_{mig}(x,p_{spec})/∂ [symbol] by −h_{spec} and ∂z_{mig}(x,h_{spec})/∂h by p_{spec}, Equation (17) can be simplified to:

$$\text{?} = \text{?} \\ \text{?} \text{indicates text missing or illegible when filed} \qquad ( 18 )$$

Equation (18) shows that the structural dip found in a common angle panel is equivalent to the dip observed in the corresponding common subsurface offset panel. Thus, according to an embodiment, the information obtained in the common angle panel can be used to solve a problem in the subsurface offset domain.

According to an embodiment, the workflow linking the focused migrated event in common angle panels built by slant stack of subsurface offset gathers to its focusing directions can be described by the following steps:

1. Pick the migrated spatial dip from the stack h=0
2. Pick the slope of the residual move-outd z̅/dp
3. Remap into z using the fact that z_{mig}(x,p)=z_{mig}(x,h)−pd z_{mig}/dp
4. Reposition starting ray position to source and receiver using d z̅_{mig}/dp=−h
5. Compute starting ray direction by solving the nonlinear system of equations linking the picked dip and opening angle to source and receiver angles.
This flow allows for recovering the stationary source and receiver positions associated to a particular focused event. Additionally, as a part of the above described workflow, the kinematic analysis occurs when the migration interval (shown above in Equation (2)) behaviour is analysed at infinite frequency with a plane wave as input data.

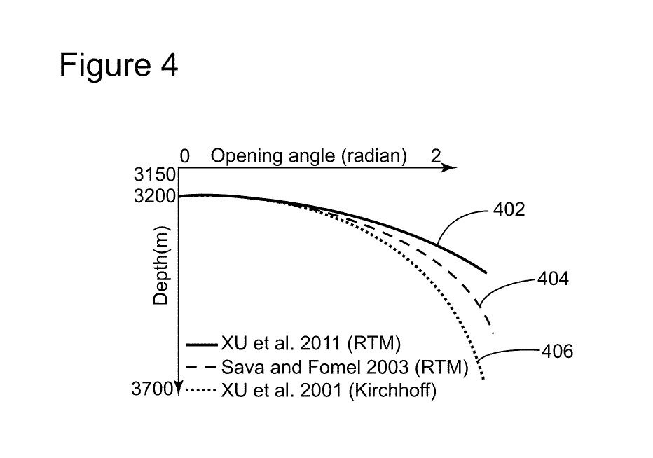

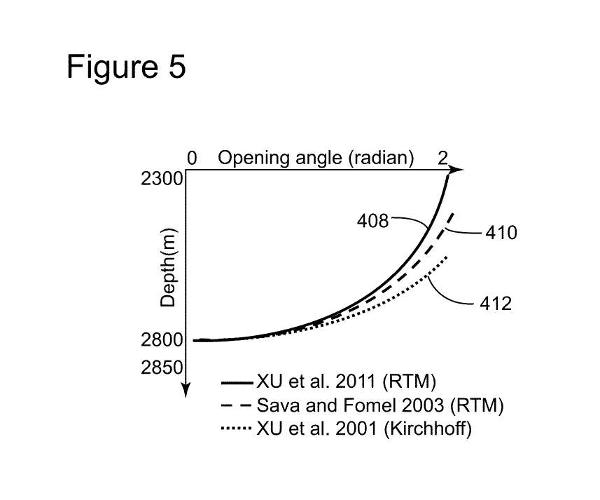

The impact, or benefits, of using kinematic analysis as described above may best be understood by considering differences in RMO curvatures associated with different gathers. For example, from the foregoing focusing analysis it is clear that one cannot expect the same RMO curvature in an ADCIG computed with the slant stack method and other gathers such as Kirchhoff migration or RTM 3D angle gather decomposition when using a wrong velocity model. This difference is shown in FIGS. 4 and 5, which depict using a simple example of a flat reflector located at 3000 m and constant 3000 m/s velocity for which various curvatures can be obtained using different migration algorithms. FIGS. 4 and 5 illustrate this phenomenon on an anisotropic synthetic dataset migrated with 105% of the correct velocities. FIGS. 4 and 5 are different in the depths of the various curvatures that are shown. Curvatures 402 and 408 are for an RTM method (Xu et al., “3D common image gathers from reverse time Migration: 80^{th} Annual International Meeting,” SEG, Expanded Abstracts, pp. 3257-3262, 2011), curvatures 404 and 410 are for a different RTM method (Sava, P., et al., “Angle-domain common gathers by wavefield continuation methods,” Geophysics, 63, pp. 1065-1074, 2003), and curvatures 406 and 412 are for a Kirchhoff method (Xu et al., “Common angle image gather—A strategy for imaging complex media:” Geophysics, 66, pp. 1877-1894, 2001).

These differences in curvature can be explained by the kinematics of those migration algorithms. By using the appropriate mathematical development of the associated imaging conditions; the calculated kinematic factors can be used for a proper update of the velocities. Thus obtaining knowledge on migration kinematics can provide the opportunity to use any type of ADCIGs for ray-based velocity (model) updates.

Embodiments described herein have analyzed the kinematical behavior of ADCIGs built by slant stack transformation of subsurface offset gathers. The development of the imaging conditions associated with this type of gather construction gives meaning to the observed differences between different ways of computing ADCIGs, and shows how to correctly handle the kinematical information contained in these gathers. According to an embodiment, these observations can be used in support of new ray-based tomography applications.

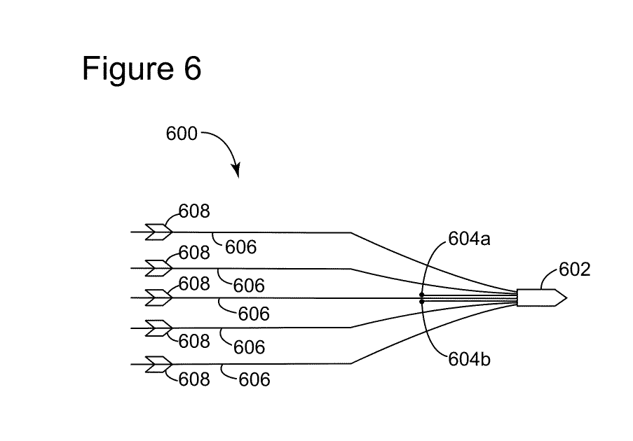

While the above described embodiments have presented using kinematic analysis to improve the output of processing land seismic data (e.g., to generate a subsurface image of a geographical area), embodiments described herein can also use acquired marine seismic data. An example of a system and an environment for acquiring such marine seismic data will now be described with respect to FIG. 6.

For a seismic gathering process, as shown in FIG. 6, a data acquisition system 600 includes a ship 602 towing plural streamers 606 that may extend over kilometers behind ship 602. Each of the streamers 606 can include one or more birds 608 that maintains streamer 606 in a known fixed position relative to other streamers 606, and the birds 608 are capable of moving streamer 606 as desired according to bi-directional communications the birds 608 can receive from ship 602. One or more source arrays 604a,b may also be towed by ship 602 or another ship for generating seismic waves. Source arrays 604a,b can be placed either in front of or behind receivers, or both behind and in front of receivers. The seismic waves generated by source arrays 604a,b propagate downward, reflect off of, and penetrate the seafloor, wherein the refracted waves eventually are reflected by one or more reflecting structures (not shown in FIG. 6) back to the surface. The reflected seismic waves propagate upwardly and are detected by receivers 610 provided on streamers 606.

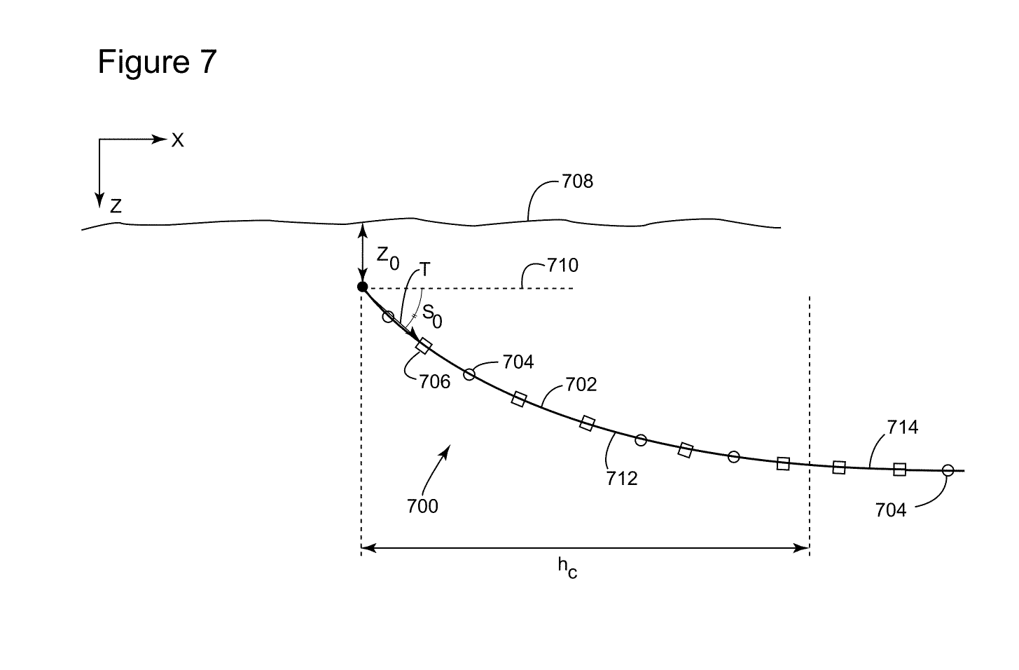

According to an embodiment, streamers may be horizontal or slanted or having a curved profile as illustrated in FIG. 7. The curved streamer 700 of FIG. 7 includes a body 702 having a predetermined length; plural detectors 704 provided along the body 702; and plural birds 706 provided along the body for maintaining the selected curved profile. The streamer 700 is configured to flow underwater when towed such that the plural detectors 704 are distributed along the curved profile. The curved profile may be described by a parameterized curve, e.g., a curve described by (i) a depth z₀ of a first detector (measured from the water surface 708), (ii) a slope s₀ of a first portion T of the body with an axis 710 parallel with the water surface 708, and (iii) a predetermined horizontal distance h_{c}, between the first detector and an end of the curved profile. It is noted that not the entire streamer has to have the curved profile. In other words, the curved profile should not be construed to always apply to the entire length of the streamer. While this situation is possible, the curved profile may be applied only to a portion 712 of the streamer 700. In other words, the streamer 700 may have (i) only a portion 712 having the curved profile or (ii) a portion 712 having the curved profile and a portion 714 having a flat profile, the two portions being attached to each other.

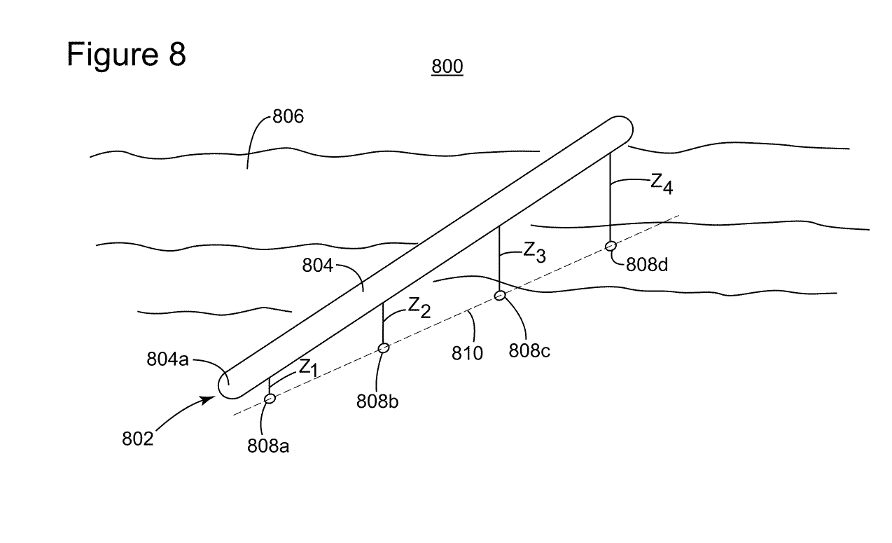

According to another embodiment, a multi-level source 800 which can have one or more sub-arrays can be used as is shown in FIG. 8. The first sub-array 802 has a float 804 that is configured to float at the water surface 806 or underwater at a predetermined depth. Plural source points 808a-d are suspended from the float 804 in a known manner. A first source point 808a may be suspended closest to the head 804a of the float 804, at a first depth z1. A second source point 808b may be suspended next, at a second depth z2, different from z1. A third source point 808c may be suspended next at a third depth z3, different from z1 and z3, and so on. FIG. 8 shows, for simplicity, only four source points 808a-d, but an actual implementation may have any desired number of source points. In one application, because the source points are distributed at different depths, the source points at the different depths are not simultaneously activated. In other words, the source array is synchronized, i.e., a deeper source point is activated later in time (e.g., 2 ms for 3 m depth difference when the speed of sound in water is 1500 m/s) such that corresponding sound signals produced by the plural source points coalesce, and thus, the overall sound signal produced by the source array appears as being a single sound signal.

The depths z1 to z4 of the source points of the first sub-array 802 may obey various relationships. In one application, the depths of the source points increase from the head toward the tail of the float, i.e., z1<z2<z3<z4. In another application, the depths of the source points decrease from the head to the tail of the float. In another application, the source points are slanted, i.e., provided on an imaginary line 810. In still another application, the line 810 is a straight line. In yet another application, the line 810 is a curved line, e.g., part of a parabola, circle, hyperbola, etc. In one application, the depth of the first source point for the sub-array 802 is about 5 m and the largest depth of the last source point is about 8 m. In a variation of this embodiment, the depth range is between 8.5 m and 10.5 m or between 11 m and 14 m. In another variation of this embodiment, when the line 810 is straight, the depths of the source points increase by 0.5 m from a source point to an adjacent source point. Those skilled in the art would recognize that these ranges are exemplary and these numbers may vary from survey to survey. A common feature of all these embodiments is that the source points have variable depths so that a single sub-array exhibits multiple-level source points.

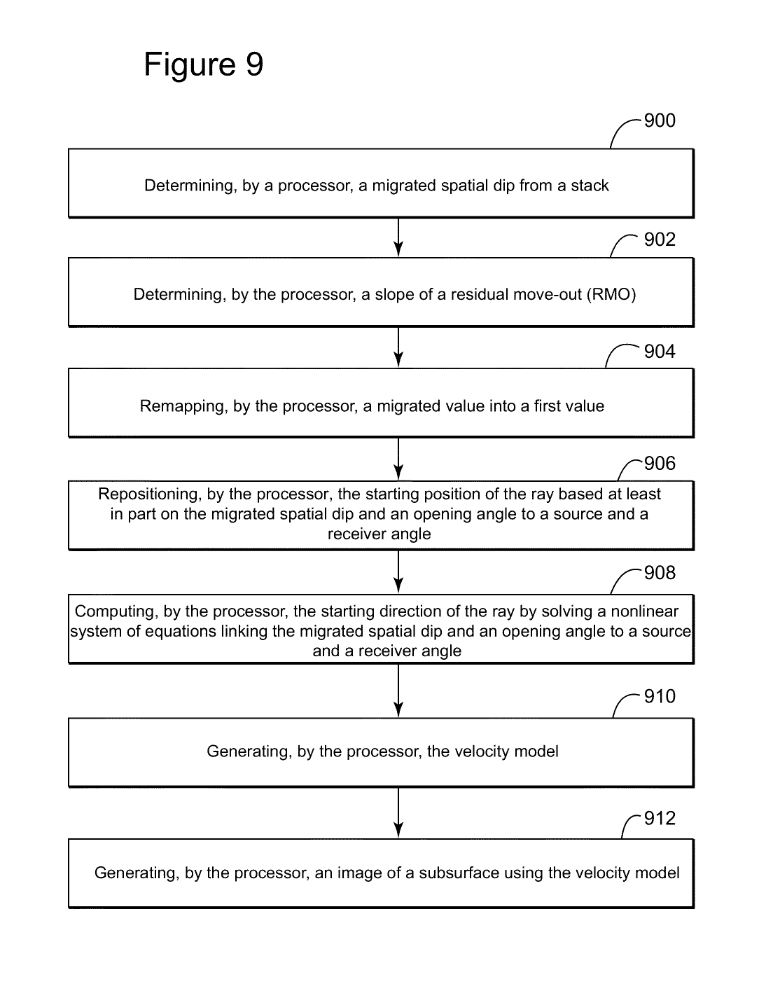

Utilizing the above-described systems according to an embodiment, there is a method for determining, by a computing device, a starting position and direction of a ray for use in generating a velocity model based at least in part on a kinematic analysis of Angle Domain Common Image Gathers (ADCIGs) obtained by a Wave Equation Migration (WEM) process as shown in FIG. 9. The method includes: at step 900, determining, by a processor, a migrated spatial dip from a stack; at step 902, determining, by the processor, a slope of a residual move-out (RMO); at step 904, remapping, by the processor, a migrated value into a first value; at step 906, repositioning, by the processor, the starting position of the ray based at least in part on the migrated spatial dip from the stack, the slope of the RMO and the first value; at step 908, computing, by the processor, the starting direction of the ray by solving a nonlinear system of equations linking the migrated spatial dip and an opening angle to a source and a receiver angle; at step 910, generating, by the processor, the velocity model; and at step 912, generating, by the processor, an image of a subsurface using the velocity model

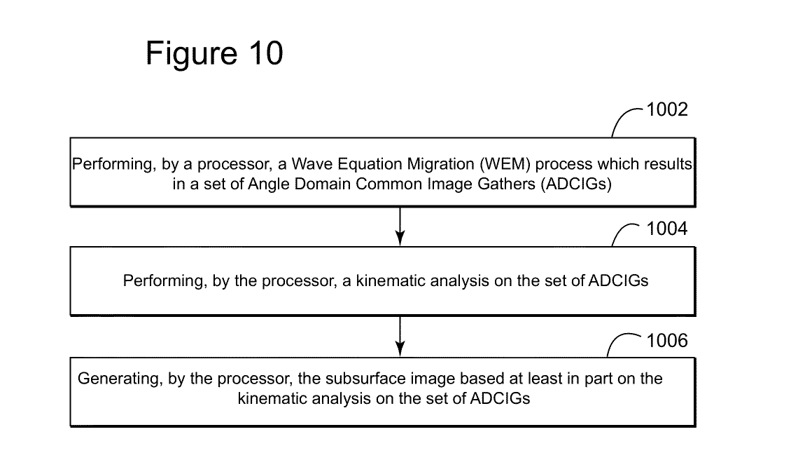

Utilizing the above-described systems according to an embodiment, there is a method for generating a subsurface image of a geographical area based on processing of seismic data as shown in FIG. 10. The method includes: at step 1000, performing, by a processor, a Wave Equation Migration (WEM) process which results in a set of Angle Domain Common Image Gathers (ADCIGs); at step 1002, performing, by the processor, a kinematic analysis on the set of ADCIGs; and at step 1004, generating, by the processor, the subsurface image based at least in part on the kinematic analysis on the set of ADCIGs.

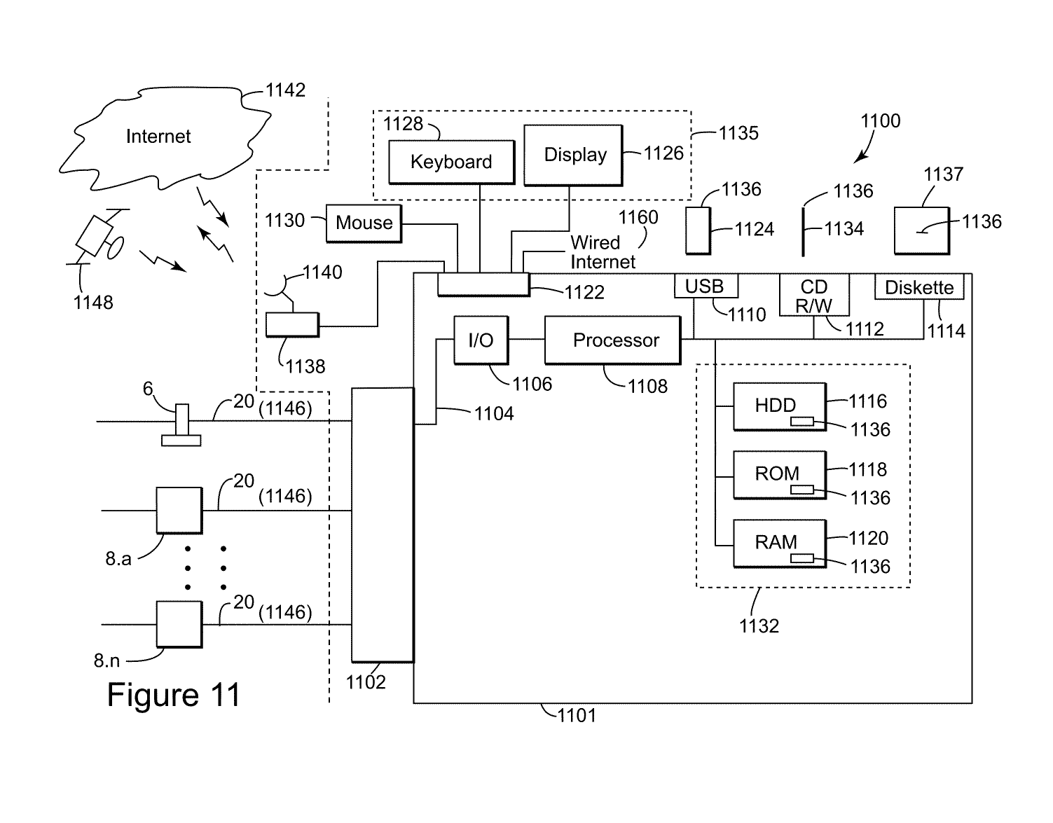

FIG. 11 illustrates a seismic data acquisition system (system) 1100 suitable for use to implement a method for determining a starting position and direction of a ray for use in generating a velocity model based at least in part on a kinematic analysis of ADCIGs obtained by a WEM process for either land or marine seismic data which can result in an image according to an embodiment. System 1100 includes, among other items, server 1101, source/receiver interface 1102, internal data/communications bus (bus) 1104, in input/output interface 1106 (optional), processor(s) 1108 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 1110, compact disk (CD)/digital video disk (DVD) read/write (R/W) drive 1112, floppy diskette drive 1114 (though less used currently, many servers still include this device), and data storage unit 1132.

Data storage unit 1132 itself can comprise hard disk drive (HDD) 1116 (these can include conventional magnetic storage media, but, as is becoming increasingly more prevalent, can include flash drive-type mass storage devices 1124, among other types), ROM device(s) 1118 (these can include electrically erasable (EE) programmable ROM (EEPROM) devices, ultra-violet erasable PROM devices (UVPROMs), among other types), and random access memory (RAM) devices 1120. Usable with USB port 1110 is flash drive device 1124, and usable with CD/DVD R/W device 1112 are CD/DVD disks 1134 (which can be both read and write-able). Usable with diskette drive device 1114 are floppy diskettes 1137. Each of the memory storage devices, or the memory storage media (1116, 1118, 1120, 1124, 1134, and 1137, among other types), can contain parts or components, or in its entirety, executable software programming code (software) 1136 that can implement part or all of the portions of the method described herein. Further, processor 1108 itself can contain one or different types of memory storage devices (most probably, but not in a limiting manner, RAM memory storage media 1120) that can store all or some of the components of software 1136.

In addition to the above described components, system 1100 also comprises user console 1135, which can include keyboard 1128, display 1126, and mouse 1130. All of these components are known to those of ordinary skill in the art, and this description includes all known and future variants of these types of devices. Display 1126 can be any type of known display or presentation screen, such as liquid crystal displays (LCDs), light emitting diode displays (LEDs), plasma displays, cathode ray tubes (CRTs), among others. User console 1135 can include one or more user interface mechanisms such as a mouse, keyboard, microphone, touch pad, touch screen, voice-recognition system, among other inter-active inter-communicative devices.

User console 1135, and its components if separately provided, interface with server 1101 via server input/output (I/O) interface 1122, which can be an RS232, Ethernet, USB or other type of communications port, or can include all or some of these, and further includes any other type of communications means, presently known or further developed. System 1100 can further include communications satellite/global positioning system (GPS) transceiver device 1138 (to receive signals from GPS satellites 1148), to which is electrically connected at least one antenna 1140 (according to an embodiment, there would be at least one GPS receive-only antenna, and at least one separate satellite bi-directional communications antenna). System 1100 can access internet 1142, either through a hard wired connection, via I/O interface 1122 directly, or wirelessly via antenna 1140, and transceiver 1138.

Server 1101 can be coupled to other computing devices, such as those that operate or control the equipment of vehicles 12a,b, via one or more networks. Server 1101 may be part of a larger network configuration as in a global area network (GAN) (e.g., internet 1142), which ultimately allows connection to various landlines.

According to a further embodiment, system 1100, being ostensibly designed for use in seismic exploration, will interface with one or more sources 6 and one or more receivers 8. These, as previously described, are attached to cables 20. As further previously discussed, sources 6 and receivers 8 can communicate with server 1101 either through electrical cable, or via a wireless system that can communicate via antenna 1140 and transceiver 1138 (collectively described as communications conduit 1146) (note that the source, receiver and cable reference numbers refer to the land seismic FIG. 1, but this is not limiting these embodiments to land seismic use only, instead similar marine seismic equipment could also be used herein, but is not also shown for reasons of brevity and clarity).

According to further embodiments, user console 1135 provides a means for personnel to enter commands and configuration into system 1100 (e.g., via a keyboard, buttons, switches, touch screen and/or joy stick). Display device 1126 can be used to show: visual representations of acquired data; source 6 and receiver 8 position(s) and status information; survey information; and other information important to the seismic data acquisition process. Source and receiver interface unit 1102 can also communicate bi-directionally with sources and receivers via communication conduit 1146 to receive land seismic data and status information related to sources 6 and receivers 8, and to provide excitation signals and control signals to source 6 and receivers 8.

Bus 1104 allows a data pathway for items such as: the transfer and storage of data that originate from either the source sensors or streamer receivers; for processor 1108 to access stored data contained in data storage unit memory 1132; for processor 1108 to send information for visual display to display 1126; or for the user to send commands to system operating programs/software 1136 that might reside in either the processor 1108 or the source and receiver interface unit 1102.

System 1100 can be used to implement methods for processing seismic data and displaying an output associated with the seismic data according to an embodiment. Hardware, firmware, software or a combination thereof may be used to perform the various steps and operations described herein. According to an embodiment, software 1136 for carrying out the above discussed steps can be stored and distributed on multi-media storage devices such as devices 1116, 1118, 1120, 1124, 1134, and/or 1137 (described above) or other form of media capable of portably storing information (e.g., universal serial bus (USB) flash drive 1124). These storage media may be inserted into, and read by, devices such as the CD-ROM drive 1112, disk drives 1114, 1116, among other types of software storage devices.

As also will be appreciated by one skilled in the art, the various functional aspects of the embodiments may be embodied in a wireless communication device, a telecommunication network, as a method or in a computer program product. Accordingly, the embodiments may take the form of an entirely hardware embodiment or an embodiment combining hardware and software aspects. Further, the embodiments may take the form of a computer program product stored on a computer-readable storage medium having computer-readable instructions embodied in the medium. Any suitable computer-readable medium may be utilized, including hard disks, CD-ROMs, digital versatile discs (DVDs), optical storage devices, or magnetic storage devices such a floppy disk or magnetic tape. Other non-limiting examples of computer-readable media include flash-type memories or other known types of memories.

Further, those of ordinary skill in the art in the field of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed, and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or nonvolatile memory such as read only memory (ROM) and/or random access memory (RAM). A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable and volatile/nonvolatile computer storage media. For example, the processor can access a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The embodiments discussed herein can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the embodiments pertains.

The disclosed embodiments provide one or more apparatus and methods for improving processing of seismic data. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims. No element, act, or instruction used in the description of the present application should be construed as critical or essential to the invention unless explicitly described as such. Also, as used herein, the article “a” is intended to include one or more items.

What is claimed is:

1. A method for determining, by a computing device, a starting position and direction of a ray for use in generating a velocity model based at least in part on a kinematic analysis of Angle Domain Common Image Gathers (ADCIGs) obtained by a Wave Equation Migration (WEM) process, the method comprising:
determining a migrated spatial dip from a stack;
determining a slope of a residual move-out (RMO);
remapping a migrated value into a first value;
repositioning the starting position of the ray based at least in part on the migrated spatial dip from the stack, the slope of the RMO and the first value; and
computing the starting direction of the ray at least in part by using kinematic analysis.

2. The method of claim 1, wherein computing the starting direction of the ray further comprises:
solving a nonlinear system of equations linking the migrated spatial dip and an opening angle to a source angle and a receiver angle.

3. The method of claim 2, wherein the nonlinear system of equations includes at least three equations.

4. The method of claim 1, wherein the starting position and direction of the ray is associated with a reflection or a refraction event.

5. The method of claim 4, wherein a first velocity of a seismic wave when transmitted from the source is different from a second velocity of the seismic wave when the seismic wave is received by the receiver after the seismic wave encounters the event.

6. The method of claim 1, wherein the method can be performed for both land seismic data and marine seismic data.

7. The method of claim 1, further comprising:
generating the velocity model; and
displaying the velocity model.

8. The method of claim 7, further comprising:
displaying, based on the velocity model, an image of a subsurface.

9. The method of claim 1, wherein the steps of determining a migrated spatial dip from a stack; determining a slope of a residual move-out (RMO); and remapping a migrated value into a first value; repositioning the starting position of the ray based at least in part on the migrated spatial dip from the stack, the slope of the RMO and the first value; are further performed at least in part using kinematic analysis which is an analysis that uses motion without reference to masses or forces.

10. The method of claim 9, wherein the kinematic analysis includes analysis of an imaging equation which governs a reverse-time migration (RTM).

11. The method of claim 1, wherein the step of repositioning the starting position of the ray further comprises using the following equations:
$$\text{?} = - \text{?}$$
$$and$$
$$\text{?} = - \text{?}$$
$$\text{?} \text{indicates text missing or illegible when filed}$$

12. A method for determining, by a computing device, a starting position and direction of a ray for use in generating a velocity model based at least in part on a kinematic analysis of Angle Domain Common Image Gathers (ADCIGs) obtained by a Wave Equation Migration (WEM) process, the method comprising:
determining, by a processor, a migrated spatial dip from a stack;
determining, by the processor, a slope of a residual move-out (RMO);
remapping, by the processor, a migrated value into a first value;
repositioning, by the processor, the starting position of the ray based at least in part on the migrated spatial dip from the stack, the slope of the RMO and the first value;
computing, by the processor, the starting direction of the ray by solving a nonlinear system of equations linking the migrated spatial dip and an opening angle to a source and a receiver angle;
generating, by the processor, the velocity model; and
generating, by the processor, an image of a subsurface using the velocity model.

13. The method of claim 12, wherein the steps of determining, by the processor, a migrated spatial dip from a stack; determining, by the processor, a slope of a residual move-out (RMO); and remapping a migrated value into a first value; repositioning, by the processor, the starting position of the ray based at least in part on the migrated spatial dip from the stack, the slope of the RMO and the first value; are further performed at least in part using kinematic analysis which is an analysis that uses motion without reference to masses or forces.

14. The method of claim 13, wherein the step of repositioning the starting position of the ray further comprises using the following equations:
$$\text{?} = - \text{?}$$
$$and$$
$$\text{?} = - \text{?}$$
$$\text{?} \text{indicates text missing or illegible when filed}$$

15. The method of claim 12, wherein the method can be performed for both land seismic data and marine seismic data.

16. A method for generating a subsurface image of a geographical area based on processing of seismic data, the method comprising:
performing, by a processor, a Wave Equation Migration (WEM) process which results in a set of Angle Domain Common Image Gathers (ADCIGs);
performing, by the processor, a kinematic analysis on the set of ADCIGs; and
generating, by the processor, the subsurface image based at least in part on the kinematic analysis on the set of ADCIGs.

17. The method of claim 16, further comprising:
displaying the subsurface image.

18. The method of claim 16, wherein a first velocity of a seismic wave when transmitted from the source is different from a second velocity of the seismic wave when the seismic wave is received by the receiver after the seismic wave encounters the event.

19. The method of claim 16, wherein the method can be performed for both land seismic data and marine seismic data.

20. The method of claim 16, wherein information associated at least in part on the kinematic analysis on the set of ADCIGs is used in support of ray-based tomography applications.
